(19) United States
(12) Patent Application Publication
(10) Pub. No.: US 2014/0002853 A1
(43) Pub. Date: Jan. 2, 2014

(54) COMPUTER READABLE MEDIUM STORING PROGRAM FOR PORTABLE TERMINAL, PORTABLE TERMINAL, AND METHOD OF DATA PROCESSING

(71) Applicant: Yuji MIYATA, Kitanagoya-shi (JP)

(72) Inventor: Yuji MIYATA, Kitanagoya-shi (JP)

(73) Assignee: BROTHER KOGYO KABUSHIKI KAISHA, Nagoya-shi (JP)

(21) Appl. No.: 13/853,271

(22) Filed: Mar. 29, 2013

(30) Foreign Application Priority Data
Jun. 29, 2012 (JP) 2012-146759

(51) Int. Cl. H04N 1/00

(52) U.S. Cl. CPC H04N 1/00482
USPC 358/1.15

(57) ABSTRACT

There is provided non-transitory computer readable medium including a program which is to be executed on a computer of a portable terminal including: a display section including four edges; and a sensor configured to output sensor data based on at least one of a proximity of an input medium to the display section, a contact of the input medium with the display section, and a posture of the portable terminal. The program causes the computer to execute displaying an image based on image data; setting a binding edge at the time of printing the image, based on the sensor data; and processing the image data based on the binding edge.

### CROSS REFERENCE TO RELATED APPLICATION

The present invention claims priority from Japanese Patent Application No. 2012-146759, filed on Jun. 29, 2012, the disclosure of which is incorporated herein by reference in its entirety.

### BACKGROUND OF THE INVENTION

1. Field of the Invention

The present invention relates to a computer-readable medium storing a computer program which is readable by a computer of a portable terminal including a display section for displaying an image, a portable terminal, and a method for data processing.

2. Description of the Related Art

Size reduction and weight reduction of portable terminals have been progressing in recent years, and in many cases, portable terminals are used while being held in hands. In view of such situations, a portable terminal in which a top and a bottom of an image displayed on the display section coincide with a top and bottom in a direction of gravitational force, has been known. Furthermore, in the abovementioned portable terminal, at the time when an image displayed on the display section is to be printed, a top and a bottom of an image displayed and a top and a bottom of an image of a document printed coincide.

### SUMMARY OF THE INVENTION

According to a technology related to the abovementioned portable terminal, it has become possible to check easily the image displayed on the image section and the image on the printed document, and therefore it is convenient. At the time of double-sided printing, it is necessary to select one of a short-edge binding and a long-edge binding. When the short-edge binding is selected, it is necessary to select one of short-edge out of two of short-edges, as a binding edge. When the long-edge binding is selected, it is necessary to select one of long-edge out of two of long-edges, as a binding edge. Because a printing method differs according to a binding position, it is necessary to select the binding edge. In detail, the printing method at the time of double-sided printing differs according to the binding edge, and whether the image to be printed is a landscape-oriented image or a portrait-oriented image. Here, the landscape-oriented image means an image which can be seen correctly when a short side of a print image 100 is extended in a direction away from the user, or in a vertical direction, and a long side of the print image 100 is extended in a left-right direction of the user, as shown in FIG. 3. Whereas, a portrait-oriented image or a vertically long image means an image which can be seen correctly when a long side of the print image 100 is extended in the direction away from the user, or in the vertical direction, and a short side of the print image 100 is extended in the left-right direction of the user. In a printing method in which a short-edge of the portrait-oriented image is set as the binding edge, an image of an odd-page is printed normally on a front surface of a printing paper and an image of an even-page is printed upside down on a rear surface of the printing paper. In a printing method in which a long-edge of the portrait-oriented image is set as the binding edge, an image of an odd-page is printed normally on a front surface of a printing paper and an image of an even-page is printed normally on a rear surface of the printing paper. In a printing method in which a short-edge of the landscape-oriented image is set as the binding edge, an image of an odd-page is printed normally on a front surface of a printing paper and an image of an even-page is printed normally on a rear surface of the printing paper. In a printing method in which a long-edge of the landscape-oriented image is set as the binding edge, an image of an odd-page is printed normally on a front surface of a printing paper and an image of an even-page is printed upside down on a rear surface of the printing paper. The printing method may differ according to a binding margin. In a printing method in which a short-edge of the printing paper is set as the binding edge, a margin at a side of the binding edge corresponding to one of two short-edges is wider than a margin at a side of the other of short-edge. In a printing method in which a long-edge of the printing paper is set as the binding edge, a margin at a side of the binding edge corresponding to one of two long-edges is wider than a margin at a side of the other of long-edge. Therefore, at the time of double-sided printing, a processing such as rotating image data of an image to be printed on the rear surface of the paper is necessary, and at the time of double-sided printing, it is necessary to select as to at which position out of the long-edge binding and the short-edge binding, to bind.

However, such selection at the time of double-sided printing is hardly described in patent publications related to the abovementioned portable terminal Therefore, for selecting between the long-edge binding and the short-edge binding, displaying a selection screen on the display section, and selecting by using a button such as a selection button may be taken into consideration. In such selection method, it is difficult for a user to know intuitively as to which position of the image is to become the binding position, and therefore operability is low. The present teaching has been made in view of the abovementioned circumstances, and provides a portable terminal with a high operability, in which it is easy for the user to know the binding position intuitively, a computer-readable medium in which a computer program readable by a computer of such portable terminal has been recorded, and a method of data processing.

According to a first aspect of the present teaching, there is provided a non-transitory computer readable medium, including a program recorded therein which is to be executed on a computer of a portable terminal including:

a display section including four edges; and a sensor configured to output sensor data based on at least one of a sliding of an input medium being in a proximity to the display section, a sliding of the input medium contacting with the display section, and a posture of the portable terminal,

wherein the program causes the computer of the portable terminal to execute:

displaying an image based on image data on the display section;

setting a binding edge based on the sensor data output from the sensor, at the time of printing the image displayed on the display section; and

processing the image data based on the set binding edge.

According to a second aspect of the present teaching, there is provided a portable terminal including:

a display section including four edges;

a sensor configured to output sensor data based on at least one of a sliding of an input medium being in a proximity to the display section, a sliding of the input medium contacting with the display section, and a posture of the portable terminal; and

a control device configured to:
displaying an image based on image data, on the display section;
setting a binding edge at the time of printing the image displayed on the image section, based on the sensor data output from the sensor; and
processing of the image data based on the set binding edge.

According to a third aspect of the present teaching, there is provided a method of data processing for image data, including:

displaying an image based on image data, on a display section including four edges;

setting a binding edge at the time of printing of the image displayed on the display section, based on sensor data output by a sensor which is configured to output the sensor data based on at least one of a sliding of an input medium being in a proximity to the display section, a sliding of the input medium contacting with the display section, and a posture of a portable terminal, and processing the image data based on the set binding edge.

In any of the cases, it is possible for a user to carry out setting of binding edge by sliding the input medium such as a finger being closer to the display section, by sliding the input medium such as a finger contacting with the display section, or by changing the posture of the portable terminal For instance, it is possible to set the binding edge by the user sliding the input medium such as a finger being closer to the display section, by the user sliding the input medium such as a finger contacting with the display section, or by the user changing the posture of the portable terminal, by executing a computer program which has been recorded in the computer-readable medium according to the present teaching. Accordingly, it is easy for the user to know intuitively the binding position which has been set by the user, and it is possible to improve an operability of the portable terminal

### BRIEF DESCRIPTION OF THE DRAWINGS

FIG. 1 is a block diagram of a communication system 1;

FIG. 2A and 2B are flowcharts of an operation of a mobile phone 10;

FIG. 3 shows an example of a landscape-oriented print image 100;

FIG. 4 is a diagram showing a display mode of the print image 100 on a panel 22 when the mobile phone 10 is held vertically;

FIG. 5 is diagram showing conceptually an example of a flick operation on a the panel 22 when the mobile phone 10 is held horizontally;

FIG. 6A and 6B are diagrams showing an example of a display mode of one print image 100 on the panel 22 of the mobile phone 10, and an example of a display mode of a plurality of print images 100 on the panel 22 of the mobile phone 10;

FIG. 7 is a diagram showing an example of a display mode of the print image 100 on the panel 22 when the mobile phone 10 is held horizontally;

FIG. 8 is a diagram showing conceptually image data in which, a binding edge is set in the mobile phone 10; and

FIGS. 9A and 9B are diagrams showing a flowchart of an operation of the mobile phone 10.

### DETAILED DESCRIPTION OF THE PREFERRED EMBODIMENTS

<First embodiment>

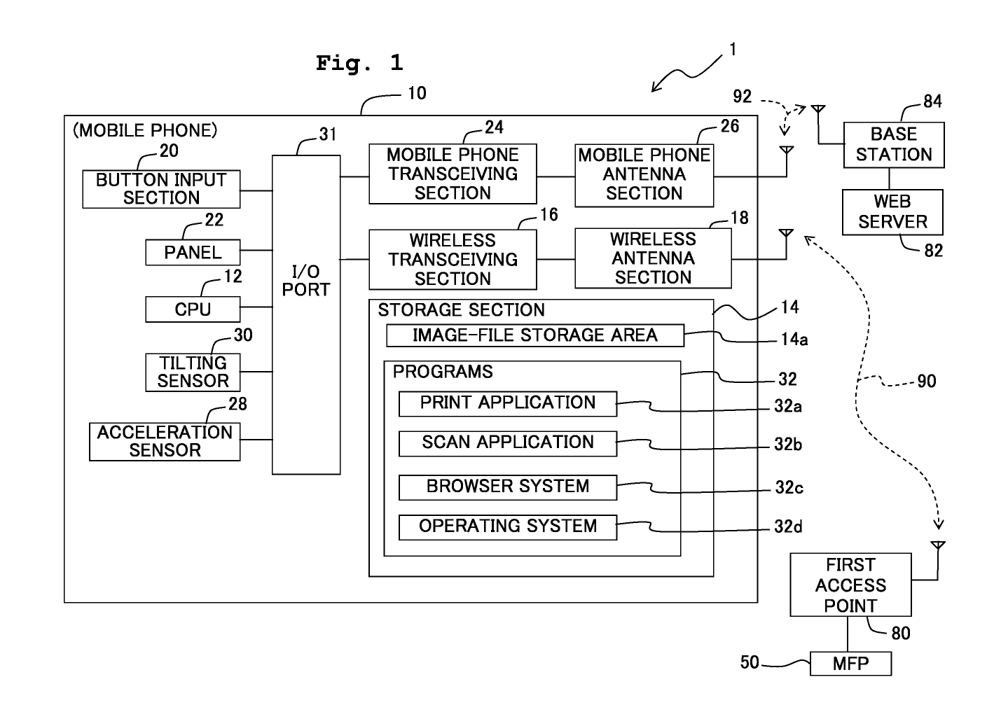

FIG. 1 shows a block diagram of a communication system 1 which is exemplified as a first embodiment according to the present patent application. The communication system 1 includes a mobile phone 10, an MFP (which stands for “multifunction peripheral”) 50, a first access point 80, a web server 82, and a base station 84. The mobile phone 10 and the MFP 50 have a function as a wireless LAN terminal equipment which is known. Moreover, the MFP 50 is a multifunction peripheral having functions such as a printer function, a scanner function, a copy functions, and a facsimile function. The first access point 80 has a function as a wireless LAN access point which is already known. The web server 82 is an equipment which provides functions and data possessed, to a client device over a network.

The mobile phone 10 and the first access point 80 are capable of carrying out data communication using radio waves or wireless communication 90 based on an infrastructure mode which is one of wireless communication methods. In other words, the mobile phone 10 becomes capable of carrying out data communication with the MFP 50 via the first access point 80 upon making an access to the access point 80, and assuming a state of being capable of carrying out the wireless communication 90 based on the infrastructure mode of wireless LAN. A communication method stipulated by IEEE802.11a/b/g/n standard can be cited as an example of a wireless LAN communication method.

A configuration of the mobile phone 10 will be described below. The mobile phone 10 includes mainly, a central processing unit 12 (hereinafter, referred as a CPU 12), a storage section 14, a wireless transceiving section 16, a wireless antenna section 18, a button input section 20, a panel 22, a mobile phone transceiving section 24, a mobile phone antenna section 26, an acceleration sensor 28, and a tilting sensor 30.

The CPU 12 executes processing according to computer programs 32 stored in the storage section 14. Hereafter, the CPU 12 which executes a computer program such a print application 32a and an operating system 32d may also be described only by a name of the computer program. For instance, a term ‘print application 32a’ may also mean ‘the CPU 12 which executes the print application 32a’. The storage section 14 is formed by a random access memory (referred as a RAM), a read only memory (referred as a ROM), a flash memory, a hard disk drive (referred as a HDD), and a buffer in the CPU 12 being combined together.

The wireless transceiving section 16 carries out the wireless communication 90 based on the infrastructure mode of wireless LAN via the wireless antenna section 18. Moreover, the mobile phone transceiving section 24 carries out a wireless communication 92 based on a mobile phone communication method with the base station 84 via the mobile phone antenna section 26. Moreover, digital signals which form various data are transceived to and from the wireless transceiving section 16 and the mobile phone transceiving section 24.

The storage section 14 stores the computer programs 32. The computer programs 32 include the print application 32a, a scan application 32b, a browser application 32c, and the operating system 32d. The print application 32a is an application for causing the CPU 12 to execute a print processing from the mobile phone 10 to the MFP 50. The scan application 32b is an application for causing the CPU 12 to execute a scan processing from the mobile phone 10 to the MFP 50. By executing a processing according to the browser application 32c, the CPU 12 is capable of executing acquisition of web data from the web server 82, storage of the web data in the storage section 14, and display of an image indicated by the web data in the storage section 14 on the panel 22.

The operating system 32d is a computer program which provides basic functions to be used in the print application 32a, the scan application 32b, and the browser application 32c. The operating system 32d includes a computer program for causing the mobile phone transceiving section 24 to execute telephonic conversation, and a computer program for causing the wireless transceiving section 16 to execute the wireless communication 90. Moreover, the operating system 32d is a computer program which provides application programming interfaces (hereinafter, referred as APIs) for each computer program to acquire information obtained by the acceleration sensor 28 and the tilting sensor 30, or for each computer program to control various hardware.

Moreover, the storage section 14 includes an image-file storage area 14a. The image-file storage area 14a is an area for storing a plurality of image files. An image file indicated by web data which has been acquired from the web server 82 or an image file of a plurality of documents which have been scanned by the MFP 50 can be cited as an example of the image file.

The panel 22 indicates various functions of the mobile phone 10. The button input section 20, which has a touch sensor and which is formed integrally with the panel 22, is configured to detect a coming closer of an input medium to the panel 22 and a contact of the input medium with the panel, and to receive button operation by a user. Furthermore, the button input section 20 is configured to detect a direction of sliding in a state of the input medium came closer or made a contact, and to receive a flick operation by the user. The acceleration sensor 28 is a sensor configured to measure an acceleration of the mobile phone 10 by detecting a change in a position of a spindle. The tilting sensor 30 is a sensor configured to measure an angle of inclination (hereinafter also referred to as a tilting angle) of the mobile phone 10 with respect to a horizontal surface by detecting an angular velocity. In other words, the tilting sensor 30 is configured to measure a direction of inclination or a direction of tilt of the mobile phone 10 with respect to a horizontal surface by detecting an angular velocity.

<Operation of Mobile Phone>

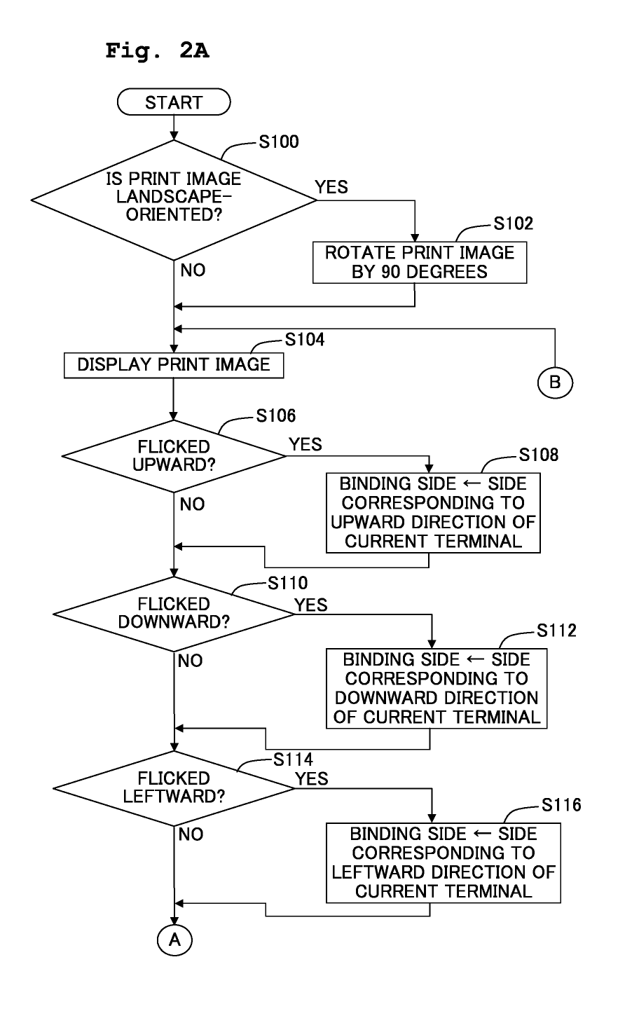

An operation of the mobile phone 10 according to the first embodiment will be described below. An image file including a plurality of image data indicated by data such as web data acquired from the web server 82 is stored in the image-file storage area 14a of the mobile phone 10. In the mobile phone 10, a processing for causing the MFP 50 to print the plurality of image data included in the image file is executed by using the print application 32a. Concretely, a flow for causing the MFP 50 to print the image data will be described below by referring to FIG. 2.

At step S100, the CPU 12 makes a judgment of whether or not an image which is to be printed, or in other words, an image based on the image data stored in the image-file storage area 14a is landscape-oriented. In a case in which the print image is landscape-oriented (Yes at step S100), the process advances to step S102. At step S102, the CPU 12 rotates the print image by 90 degrees. Then, the process advances to step S104, and at step S104, the CPU 12 displays the print image on the panel 22.

The direction away from the user, or the vertical direction may be described as a first direction, and the left-right direction of the user may be described as a second direction. Moreover, the first direction includes the direction of away from the user, and the first direction includes not only a direction of away in a horizontal direction but also a direction of away in a direction inclined from the horizontal direction. In other words, the first direction includes a direction which is inclined at a predetermined angle of smaller than 90 degrees from the vertical direction. Particularly, by letting the predetermined angle to be in a range of 45 degrees to 90 degrees, the user is capable of holding the mobile phone 10 vertically upon raising a little from a horizontal state, thereby making it easy to hold the mobile phone 10.

Moreover, regarding the direction of orientation of an image, a landscape-oriented image can be defined in another way as described below. Suppose that an image is displayed on the panel 22 upon letting a vertical direction of the panel 22 and a short edge direction of the image to coincide. Then, when the user has viewed the panel 22 upon being positioned at a side of a lower edge of the panel 20, or upon being positioned at a side near to a button installed on the mobile phone 10, the landscape-oriented image can be viewed correctly, or, turned upside down. Whereas, a portrait-oriented image can be defined in another way as described below. Suppose that an image is displayed on the panel 22 upon letting the vertical direction of the panel 22 and a short edge direction of the image to coincide. Then, the portrait-oriented image can be viewed correctly, or, turned upside down, when the user has viewed the panel 22 upon being positioned at the side of the panel 20 or upon being positioned at a side near to the button installed on the mobile phone 10.

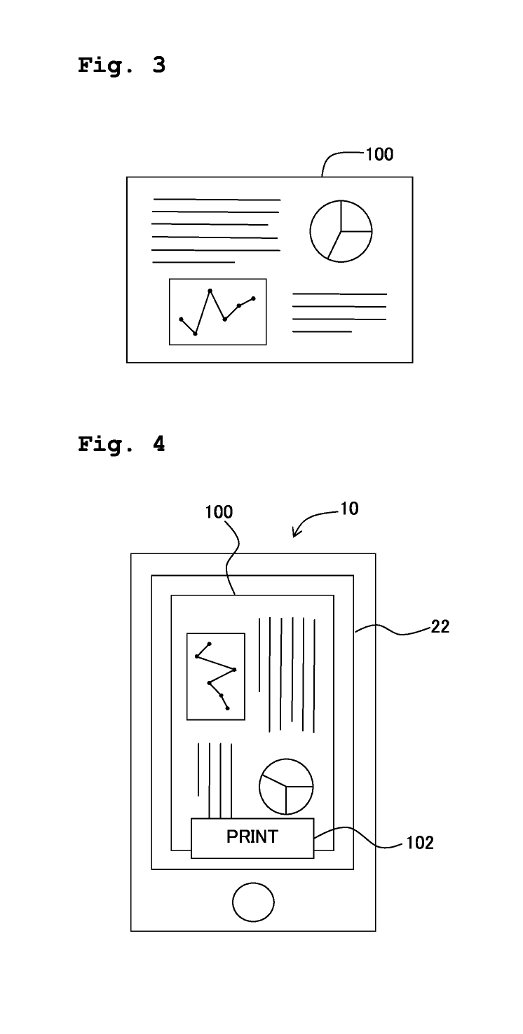

Moreover, when the print image 100 is landscape-oriented, the print image 100 which is landscape-oriented is turned by 90 degrees, and as shown in FIG. 4, is displayed on the panel 22 of the mobile phone 10. Whereas, at step S100, when the print image is not landscape-oriented (No at step S100), or in other words, when the print image is a portrait-oriented image, the process advances to step S104, and at step S104, the CPU 12 displays the print image on the panel 22.

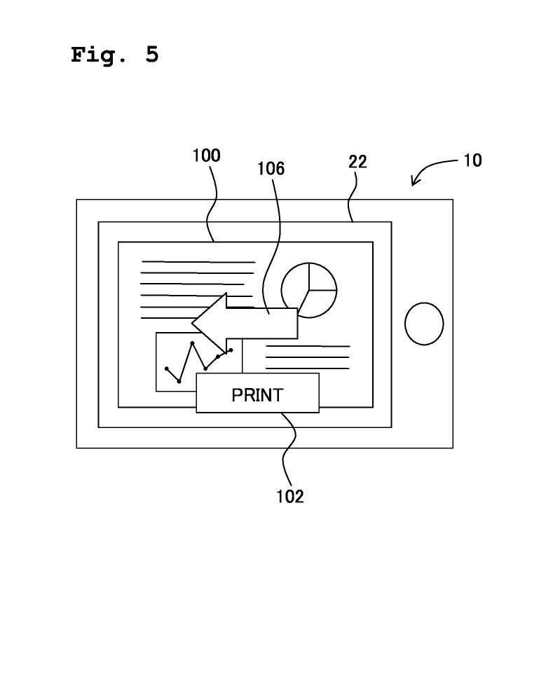

Moreover, a print button 102 for executing a print processing is displayed on the panel 22 on which the print image 100 is displayed. The print button 102 displays the print image having a display mode changed according to a portrait mode or a landscape, on the panel 22. The portrait mode is a mode in which the user facing the panel 22 is able to see a display content of the print button 102 correctly in a case in which a short edge of the panel 22 is extended in the second direction and a long edge of the panel 22 is extended in the first direction as shown in FIG. 4. Whereas, the landscape mode is a mode in which the user facing the panel 22 is able to see the display content of the print button 102 correctly in a case in which the long edge of the panel 22 is extended in the second direction and the short edge of the panel 22 is extended in the first direction as shown in FIG. 5.

Incidentally, when the print button 102 is displayed on the panel, the display mode of the print button 102 is determined based on a current posture of the mobile phone 10. Concretely, the CPU 12 acquires an angle of inclination or tilting from the tilting sensor 30, and computes the current posture of the mobile phone 10 by using the angle of inclination which has been acquired. For instance, in a case in which the mobile phone 10 is computed to have tilted such the long edge of the panel 22 is extended in the second direction and the short edge of the panel 22 is extended in the first direction, the print button 102 is displayed in the landscape mode. A posture in which the print button 102 is displayed in the landscape mode is a landscape posture. Moreover, in a case in which the mobile phone 10 is computed to have tilted such that the long edge of the panel 22 is extended in the first direction and the short edge of the panel 22 is extended in the second direction, the print button 102 is displayed in the portrait mode. A posture in which the print button 102 is displayed in the portrait mode is a portrait posture.

There are two types of postures of the mobile phone 10 with the long edge of the panel 22 extended in the second direction and the short edge of the panel 22 extended in the first direction. Concretely, the two types of postures are, a posture in which the short edge toward the button out of the pair of short edges of the mobile phone 10 is positioned at a side near the user (hereinafter, referred to as a posture in forward direction) and a posture in which the short edge toward the button out of the pair of short edges of the mobile phone 10 is positioned at a side away from the user (hereinafter, referred to as a posture of vertical flip). The two postures mentioned above are also computed by using the angle of inclination which has been acquired, and the print button 102 is displayed according to each posture. Moreover, there are two types of postures of the mobile phone 10 with the long edge of the panel 22 extended in the first direction and the short edge of the panel 22 extended in the second direction. Concretely, the two types of postures are, a posture in which the short edge toward the button out of the pair of short edges of the mobile phone 10 is positioned at a right side of a observing point of the user (hereinafter, referred to as a posture of 90 degree rotation to left), and a posture in which the short edge toward the button out of the pair of short edges of the mobile phone 10 is positioned at a left side of a observing point of the user (hereinafter, referred to as a posture of 90 degree rotation to right). The two postures mentioned above are also computed by using the angle of inclination which has been acquired, and the print button 102 is displayed according to each posture.

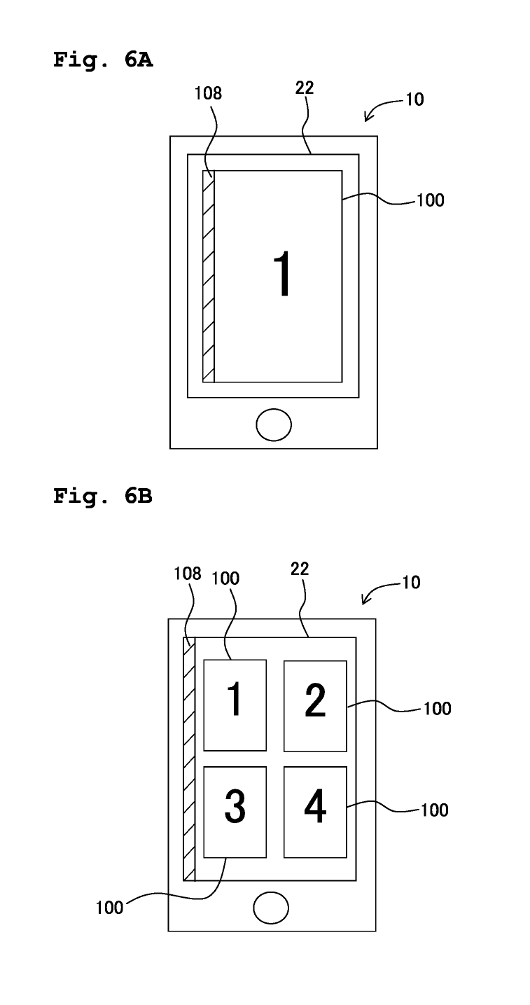

Moreover, in the mobile phone 10, at the time of displaying a print image on the panel 22, it is possible to select from a mode of displaying one print image 100 on the panel 22 (refer to FIG. 6A) and a mode of displaying four print images 100 on the panel 22 (refer to FIG. 6B). Incidentally, the selection from the two modes is carried out by a button input to the button input section 20.

As the print image 100 is displayed on the panel 22, at step S106, the CPU 12 makes a judgment of whether or not a flick operation in vertical direction has been carried out. Concretely, the CPU 12 recognizes, as an upper edge, one edge which is positioned at an upper side of a observing point of the user out of the four edges which are included in the panel 22 based on the posture of the mobile phone 10 which has been computed at the time of display of the print button 102. Note that the four edges which are included in the panel 22 can be referred to as the four edges which demarcate the panel 22. In other words, in a case in which the posture of the mobile phone 10 is the forward posture, a short edge on an opposite side of the button out of the pair of short edges of the mobile phone is the upper edge, and in a case in which the posture of the mobile phone 10 is the vertically-flipped posture, a short edge on the button side out of the pair of short edges of the mobile phone 10 is the upper edge. Moreover, in a case in which the posture of the mobile phone 10 is the posture of 90 degree rotation to right or the posture of 90 degree rotation to left, a long edge which is positioned at an upper side of a observing point of the user out of the pair of long edges of the mobile phone 10 is the upper edge. The CPU 12 makes a judgment of whether or not a flick operation has been carried out toward the upper edge. Note that the CPU 12 can recognize, as an upper edge, one edge which is positioned at an upper side of the observing point of the user out of the four edges included in the image displayed in the panel 22, and judge whether or not a flick operation has been carried out toward the upper edge. It can be considered that, at step S106, the CPU 12 relatively identify each of the four edges (that is, the upper edge, the lower edge, the left edge and the right edge) included in the panel 22 based on the posture of the mobile phone 10.

In a case in which a judgment is made that the flick operation has been carried out toward the upper edge (Yes at step S106), the process advances to step S108. At step S108, the CPU 12 sets the upper edge in the current posture of the mobile phone 10 to be the edge of binding. Furthermore, the process advances to step S110. Whereas, in a case in which, a judgment is made that the flick operation has not been carried out toward the upper edge (No at step S106), the process advances to step S110.

At step S110, the CPU 12 makes a judgment of whether or not a flick operation toward a lower edge has been carried out. Concretely, the CPU 12, similarly as at step S106, recognizes, as a lower edge, one edge which is positioned at a lower side of the observing point of the user out of the four edges which are included in the panel 22 based on the posture of the mobile phone 10. In other words, in a case in which the posture of the mobile phone 10 is the forward posture, a short edge on the side of the button out of the pair of short edges of the mobile phone 10 is the lower edge, and in a case in which a short edge on an opposite side of the button out of the pair of short edges of the mobile phone is the lower edge. Moreover, in a case in which the posture of the mobile phone 10 is the posture of 90 degree rotation to right or the posture of 90 degree rotation to left, a long edge which is positioned at a lower side of the observing point of the user out of the pair of long edges of the mobile phone 10 is the lower edge. The CPU 12 makes a judgment of whether or not a flick operation has been carried out toward the lower edge. Note that the CPU 12 can recognize, as a lower edge, one edge which is positioned at a lower side of the observing point of the user out of the four edges included in the image displayed in the panel 22, and judge whether or not a flick operation has been carried out toward the lower edge.

In a case in which a judgment is made that the flick operation has been carried out toward the lower edge (Yes at step S110), the process advances to step S112. At step S112, the CPU 12 sets the lower edge in the current posture of the mobile phone 10 to be the binding edge. Further, the process advances to step S114. Whereas, in a case in which a judgment is made that the flick operation has not been carried out toward the lower edge (No at step S110), the process advances to step S114.

At step S114, the CPU 12 makes a judgment of whether or not a flick operation has been carried out in a leftward direction. Concretely, the CPU 12, similarly as at step S106, recognizes, as a left edge, one edge which is positioned at a left side of observing point of the user out of the four edges which are included in the panel 22 based on the posture of the mobile phone 10. In other words, in a case in which the posture of the mobile phone 10 is the posture of 90 degree rotation to right, the short edge on the button side out of the pair of short edges of the mobile phone 10 is the left edge, and in a case in which the posture of the mobile phone 10 is the posture of 90 degree rotation to left, the short edge on the opposite of the button side out of the pair of short edges of the mobile phone 10 is the left edge. Moreover, in a case in which the posture of the mobile phone 10 is the forward posture or the vertically-flipped posture, a long edge which is positioned at a left side of the observing point of the user out of the pair of long edges of the mobile phone 10, is the left edge. The CPU 12 makes a judgment of whether or not a flick operation has been carried out toward the left edge. Note that the CPU 12 can recognize, as a left edge, one edge which is positioned at a left side of the observing point of the user out of the four edges included in the image displayed in the panel 22, and judge whether or not a flick operation has been carried out toward the left edge.

In a case in which a judgment is made that the flick operation has been carried out toward the upper edge (Yes at step S114), the process advances to step S116. At step S116, the CPU 12 sets the left edge in the current posture of the mobile phone 10 to be the binding edge. Furthermore, the process advances to step S118. Whereas, in a case in which a judgment is made that the flick operation has not been carried out toward the left edge (No at step S114), the process advances to step S118.

At step S118, the CPU 12 makes a judgment of whether or not a flick operation has been carried out in a rightward direction. Concretely, the CPU 12, similarly as at step S106, recognizes, as a right edge, one edge which is positioned at a right side of observing point of the user out of the four edges which are included in the panel 22 based on the posture of the mobile phone 10. In other words, in a case in which the posture of the mobile phone 10 is the posture of 90 degree rotation to left, the short edge on the button side out of the pair of short edges of the mobile phone 10 is the right edge, and in a case in which, the posture of the mobile phone is the posture of 90 degree rotation to right, the short edge on the opposite side of the button side out of the pair of short edges of the mobile phone 10 is the right edge. Moreover, in the case in which, the posture of the mobile phone 10 is the forward posture or the vertically-flipped posture, the long edge which is positioned at a right side of the observing point of the user out of the pair of long edges of the mobile phone 10 is the right edge. Next, the CPU 12 makes a judgment of whether or not a flick operation has been carried out toward the right edge. Note that the CPU 12 can recognize, as a right edge, one edge which is positioned at a right side of the observing point of the user out of the four edges included in the image displayed in the panel 22, and judge whether or not a flick operation has been carried out toward the right edge.

In a case in which a judgment is made that the flick operation has been carried out toward the right edge (Yes at step S118), the process advances to step S120. At step S120, the CPU 12 sets the right edge in the current posture of the mobile phone 10 to be the binding edge. Furthermore, the process advances to step S122. Whereas, in a case in which a judgment is made that the flick operation has not been carried out toward the right edge (No at step S118), the process advances to step S122.

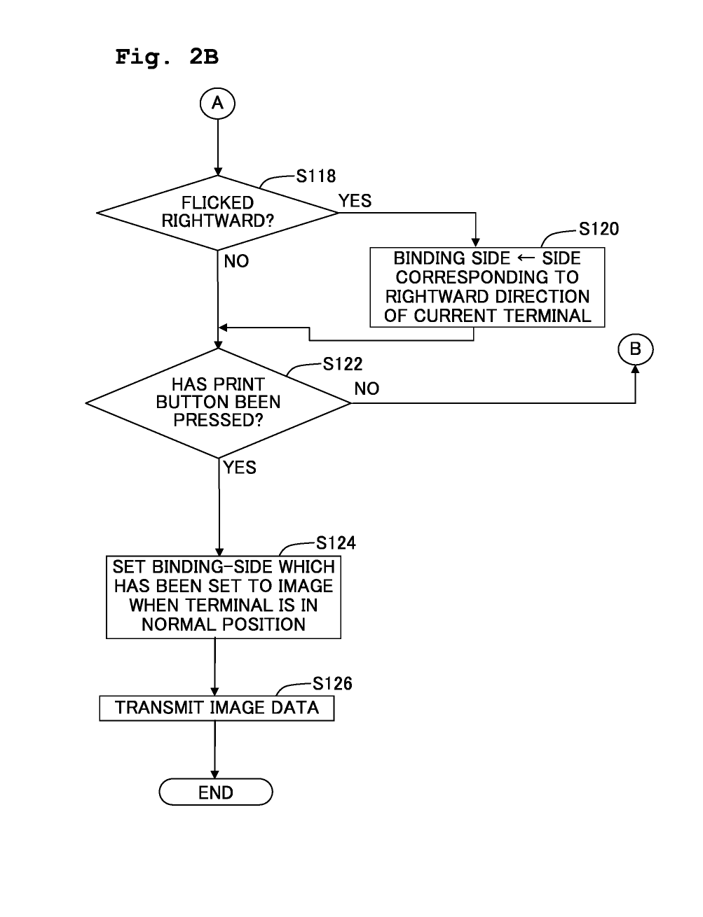

Here, a concrete method of operation of the mobile phone 10 at the time of setting the binding edge will be described below. In a case in which the landscape-oriented image as shown in FIG. 3 is displayed on the panel 22, generally, the user sees the image displayed on the panel 22 with the mobile phone 10 held horizontally as shown in FIG. 5. Holding horizontally is a manner of holding in which the posture of the mobile phone 10 is either the posture of 90 degree rotation to right or the posture of 90 degree rotation to left.

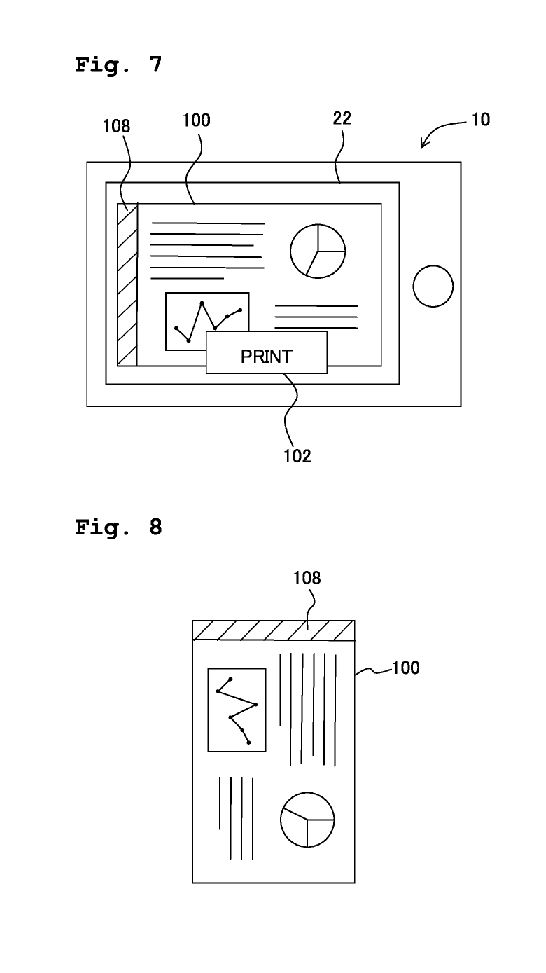

As shown by an arrow 106 in FIG. 5, when the user carries out the flick operation toward the left edge of observing point of the user on the panel 22 of the mobile phone 10 which has been held horizontally in such manner, the left edge of the panel 22 is set as the binding edge. Moreover, as the binding edge is set, a hatched portion 108 is displayed in a portion corresponding to the binding edge of the print image 100 displayed on the panel 22 as shown in FIG. 7.

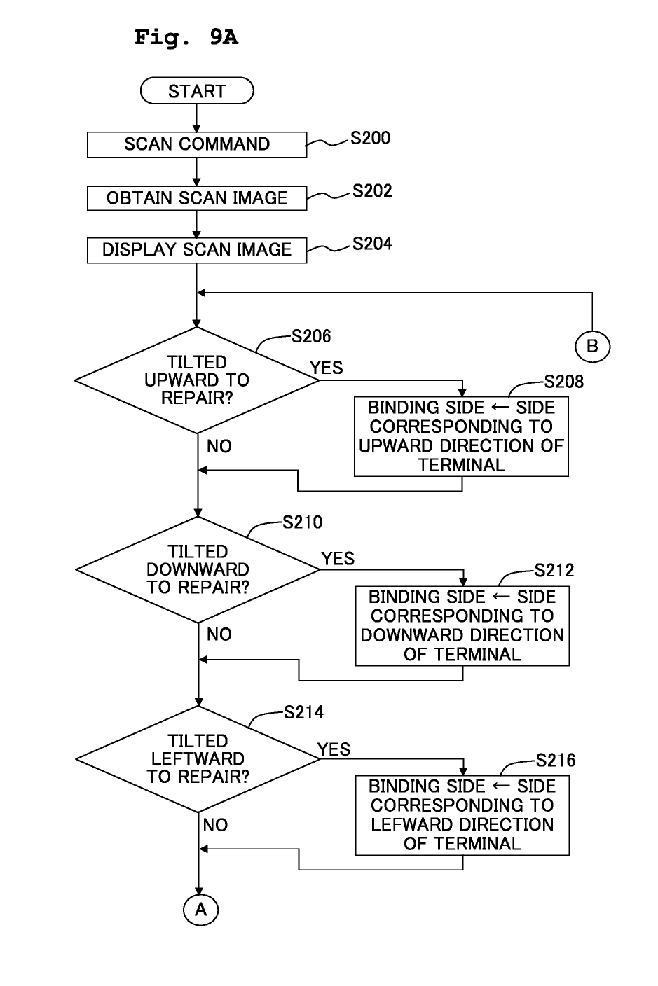

As mentioned above, as the portion corresponding to the binding edge of the print image 100 is set, at step S122, the CPU 12 makes a judgment of whether or not the print button 102 has been pressed. In a case in which the print button 102 has not been pressed (No at step S122), the process returns to step S104. Whereas, in a case in which the print button 102 has been pressed (Yes at step S122), the process advances to step S124. At step S124, the CPU 12 sets the binding edge for an image in a state of a normal position of the mobile phone 10, or in other words, when the mobile phone 10 is held vertically. More elaborately, the binding edge is set for the print image 100 in the state of the mobile phone 10 held vertically, and image data which becomes basis of the print image 100 as shown in FIG. 8 is created. In the first embodiment, vertical-holding is a manner of holding in which the posture of the mobile phone 10 becomes the posture in forward direction. However, it is also possible that a manner of holding in which the posture of the mobile phone 10 becomes the vertically-flipped posture, can be called as vertical-holding.

In such manner, as the image data is created according to the binding edge which has been set, at step S126, the CPU 12 transmits the created image data, to the MFP 50. More elaborately, the created image data is transmitted to the wireless antenna section 18 via the wireless transceiving section 16, and is transmitted to the MFP 50 via the first access point 80 by the wireless communication 90 in accordance with the infrastructure mode of the wireless LAN. Next, the flow ends.

In the MFP 50, double-sided print processing is carried out based on the plurality of image data which have been sent. In other words, at step S126, the CPU 12 transmits a command for the double-sided print processing together with the image data.

<Effect>

In the mobile phone 10 according to the first embodiment, as shown in FIG. 5, when the user carries out the flick operation toward any one of the four edges of the panel 22 on which the print image 100 has been displayed, an edge portion of the print image 100 corresponding to that one edge is set as the binding edge. In other words, by the user sliding an input medium such as a finger to turn over or flip the plurality of documents which are bound, a direction of sliding of the input medium is set as the binding edge of the print image 100. Accordingly, the user is capable of setting the binding edge of the print image 100 intuitively.

Moreover, a position of the binding edge which has been set by the flick operation is displayed as the hatched area 108 on the panel 22 as shown in FIG. 7. Accordingly, the user is capable of checking visually the position of the binding edge which has been set by the user, and it is possible to check the position of the binding position before the image is printed.

Moreover, at the time of setting the binding edge of the print image 100, a judgment of as to toward which edge out of the four edges of the panel 22 the flick operation has been carried out is made. In other words, not a judgment of as to toward which edge of the print image 100 the flick operation has been carried out is made, but a judgment of as to toward which edge of a display screen of the print image 100 the flick operation has been carried out is made. Accordingly, when the plurality of print images 100 is displayed on the panel 22 as shown in FIG. 6B for instance, not that the binding edge is set for each of the plurality of print images 100, but it becomes possible to set the binding edge for one document on which the plurality of print images 100 is printed.

Moreover, the image data to be sent from the mobile phone 10 to the MFP 50 is data for which the binding edge has been set for the print image 100 in the state of the mobile phone 10 held vertically. In other words, even when it is a landscape-oriented print image 100, image data which is a basis for the print image 100 in a portrait state or a vertical state is transmitted from the mobile phone 10 to the MFP 50. This is because paper to be used in the MFP 50 are generally set on a feed tray of the MFP 50 in the portrait state in many cases. However, in a case of the MFP 50 in which it is possible to set paper in a landscape state, regarding a landscape-oriented print image 100, it is possible that image data which is a basis for the print image 100 in a landscape state is transmitted from the mobile phone 10 to the MFP 50. Then, it is possible to print an image appropriately on a paper even when a company name etc. is already printed on an edge of the paper in advance.

### Second Embodiment

An operation of the mobile phone 10 according to a second embodiment will be described below. Since a configuration of the communication system 1 including the mobile phone 10 in the second embodiment is same as the configuration of the communication system 1 in the first embodiment, the description thereof will be omitted here.

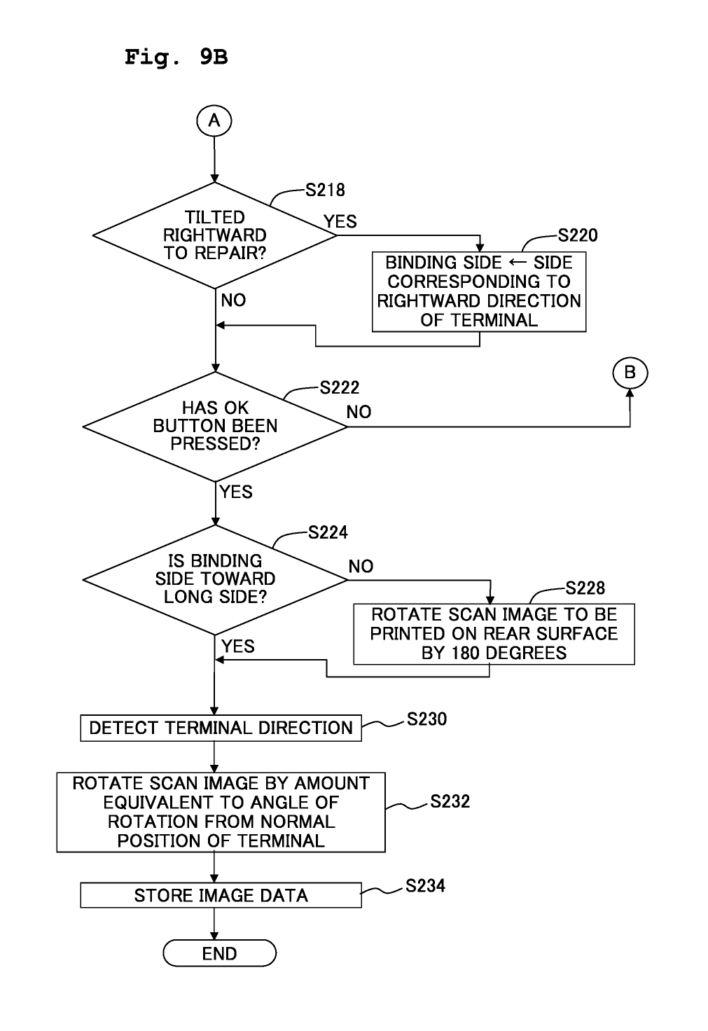

In the mobile phone 10 according to the second embodiment, a plurality of documents set in the MFP 50 is scanned by using the scan application 32b, and a processing for setting a binding edge to image data of the scanned documents is executed. Concretely, a flow for setting the binding edge to the image data of the scanned documents will be described below by referring to FIGS. 9A and 9B.

At step S200, the CPU 12 transmits a command to execute a scan processing to the MFP 50. The MFP 50 scans the plurality of documents set on a feed tray in accordance with receiving the command, and generates plurality of image data. Moreover, the process advances to step S202. At step S202, the CPU 12 acquires the plurality of image data from the MFP 50 and stores the plurality of acquired image data in the image-file storage area 14a temporarily. Next, the process advances to step S204.

At step S204, the CPU 12 displays a scan image stored in the image-file storage area 14a on the panel 22. In a case in which the scan image is landscape-oriented, the scan image is rotated by 90 degrees similarly as in a method of display at the time of print processing in the first embodiment. Moreover, an OK button (not shown in the diagram) instead of the print button 102 displayed on the panel 22 at the time of print processing in the first embodiment is displayed on the panel 22 on which the scan image is displayed. Next, the process advances to step S206. A display mode of the OK button is changed according to the posture of the mobile phone 10 similarly as the display mode of the print button 102.

At step S206, the CPU 12 makes a judgment of whether or not the mobile phone 10 has been tilted upward and then returned to original state. Concretely, the CPU 12 recognizes an edge positioned at an upper side of the observing point of the user out of the four edges which are included in the panel 22 to be an upper edge, based on the posture of the mobile phone 10 which has been computed at the time of display of the OK button. Note that the CPU 12 can recognize, as an upper edge, one edge which is positioned at an upper side of the observing point of the user out of the four edges included in the image displayed in the panel 22. Since recognition of the upper edge is same as the recognition of the upper edge in the first embodiment, the description thereof will be omitted. Further, recognition of the lower, left, and right edges is also same as the recognition of those in the first embodiment, the description thereof will be omitted. Moreover, the CPU 12 acquires an angle of inclination (also referred to as a tilting angle) consecutively from the tilting sensor 30 using the API, and computes a direction in which the mobile phone 10 is tilted, or in other words, computes a tilting direction of the mobile phone 10 (also referred to as a direction of tilt of the mobile phone 10) by using an angle of inclination which has been acquired consecutively. The tilting direction includes: a direction which is directed from a mounting surface of the mobile phone 10, on which the panel 22 has been mounted on a casing of the mobile phone 10 to a no-mounting surface on which the panel 22 has not been mounted; and a direction which is directed from the no-mounted surface to the mounted surface. The direction directed from the mounted surface to the no-mounted surface is also described as a ‘first tilting direction’, and the direction directed from the no-mounted surface to the mounted surface is also described as a ‘second tilting direction’. Note that the no-mounted surface may be a rear surface of the mounting surface of the mobile phone 10.

As the tilting direction of the mobile phone 10 is computed, the CPU 12 makes a judgment of whether or not the mobile phone 10 was tilted such that the upper edge was directed toward the first tilting direction. In a case in which the mobile phone 10 was tilted such that the upper edge was directed toward the first tilting direction, the CPU 12 makes a judgment of whether or not the mobile phone 10 was tilted such that the upper edge was directed toward the second tilting direction.

When a judgment is made that the mobile phone 10 was tilted upward and then returned to the original state (Yes at step S206), the process advances to step S208. At step S208, the CPU 12 sets the upper edge in the current posture of the mobile phone 10 to be the binding edge. Next, the process advances to step S210. Whereas, when a judgment is made that the mobile phone 10 was not tilted upward and has not returned from upward (No at step S206), the process advances to step S210.

At step S210, the CPU 12 makes a judgment of whether or not the mobile phone 10 was tilted downward and then returned to original state. Concretely, the CPU 12 recognizes an edge positioned at a lower side of the observing point of the user out of the four edges which are included in the panel 22 to be a lower edge, based on the posture of the mobile phone 10 similarly as at step S206, and computes the tilting direction of the mobile phone 10. Moreover, the CPU 12 makes a judgment of whether or not the mobile phone 10 was tilted such that the lower edge was directed in the first tilting direction, and in a case in which the mobile phone 10 was tilted such that the lower edge was directed in the first tilting direction, a judgment of whether or not the mobile phone 10 was tilted such that the lower edge was directed in the second tilting direction is made.

When a judgment is made that the mobile phone 10 was tilted downward and then returned to the original state (Yes at step S210), the process advances to step S212. At step S212, the CPU 12 sets the lower edge in the current posture of the mobile phone 10 to be the binding edge. Next, the process advances to step S214. Whereas, when a judgment is made that the mobile phone 10 was not tilted downward and has not been returned from downward (No at step S210), the process advances to step S214.

At step S214, the CPU 12 makes a judgment of whether or not the mobile phone 10 has been tilted leftward and then returned to the original state. Concretely, the CPU 12 recognizes an edge positioned at a left side of the observing point of the user out of the four edges which are included in the panel 22 to be the left edge, based on the posture of the mobile phone 10, similarly as at step S206, and computes the tilting direction of the mobile phone 10. Moreover, the CPU 12 makes a judgment of whether or not the mobile phone 10 was tilted such that the left edge was directed in the first tilting direction. In a case in which the mobile phone 10 was tilted such that the left edge was directed in the first tilting direction, the CPU 12 makes a judgment of whether or not the mobile phone 10 was tilted such that the left edge was directed in the second tilting direction.

When a judgment is made that the mobile phone 10 was tilted leftward and then returned to the original state (Yes at step S214), the process advances to step S216. At step S216, the CPU 12 sets the left edge in the current posture of the mobile phone 10 to be the binding edge. Next, the process advances to step S218. Whereas, when a judgment is made that the mobile phone 10 was not tilted leftward and has not been returned from leftward(No at step S214), the process advances to step S218.

At step S218, the CPU 12 makes a judgment of whether or not the mobile phone 10 was tilted rightward and then returned to the original state. Concretely, the CPU 12 recognizes an edge positioned at a right side of the observing point of the user out of the four edges which are included in the panel 22 to be the right edge, based on the posture of the mobile phone 10, similarly at step S206, and computes the tilting direction of the mobile phone 10. Moreover, the CPU 12 makes a judgment of whether or not the mobile phone 10 was tilted such that the right edge was directed in the first tilting direction. In a case in which the mobile phone 10 was tilted such that the right edge was directed in the first tilting direction, the CPU 12 makes a judgment of whether or not the mobile phone 10 was tilted such that the right edge was directed in the second tilting direction.

When a judgment is made that the mobile phone 10 was tilted rightward and then returned to the original state (Yes at step S218), the process advances to step S220. At step S220, the CPU 12 sets the right edge in the current posture of the mobile phone 10 to be the binding edge. Next, the process advances to step S222. Whereas, when a judgment is made that the mobile phone 10 was not tilted rightward and has not been returned from rightward(No at step S218), the process advances to step S222.

At step S222, the CPU 12 makes a judgment of whether or not the OK button displayed on the panel 22 has been pressed. In a case in which the OK button has not been pressed (No at step S222), the process returns to step S206. Whereas, in a case in which, the OK button has been pressed (Yes at step S222), the process advances to step S224.

At step S224, the CPU 12 makes a judgment of whether or not the binding edge which has been set is positioned toward the long edge. In other words, a judgment of whether or not the binding edge which has been set is in the pair of long edges out of the four edges which are included in the panel 22, is made. In a case in which the binding edge is not positioned toward the long edge (No at step S224), the process advances to step S228.

At step S228, the CPU 12 rotates scan data of a scan image which is to be printed on a rear surface at the time of double-sided printing by 180 degrees. In other words, the CPU 12 rotates odd-numbered image data or even-numbered image data from among image data of a plurality of scan images by 180 degrees. Next, the process advances to step S230. Incidentally, in a short-edge binding at the time of double-sided printing, a top and a bottom when a front surface of a document is viewed and a top and a bottom when a rear surface of the document is viewed become upside down. Therefore, by rotating the odd-numbered image data or the even-numbered image data from among the image data of the plurality of scan images by 180 degrees, image data corresponding to the short-edge binding for the double-sided printing is created.

Whereas, in a case in which the binding edge is positioned toward the long edge (Yes at step S224), the process advances to step S230. Incidentally, in a long-edge binding at the time of double-sided printing, a top and a bottom when a front surface of a document is viewed and a top and a bottom when a rear surface of the document is viewed are same. Therefore, even without carrying out the rotation processing for the image data of the plurality of scan images, image data corresponding to the long-edge binding for the double-sided printing is created.

At step S230, the CPU 12 detects a direction of a terminal. Concretely, the CPU 12 acquires a tilting angle from the tilting sensor 30 by using the API, and computes a current posture of the mobile phone 10 by using the acquired tilting angle. Moreover, a state of the mobile phone 10 is detected, or in other words, it is detected as to which state the mobile phone 10 has assumed from among a state of a normal position, a state of being flipped from the normal position, or in other words, a state of being turned by 180 degrees, a state of being turned in leftward direction by 90 degrees from the normal position, and a state of being turned in rightward direction by 90 degrees from the normal position. As the direction of terminal is detected, the process advances to step S232.

At step S232, the CPU 12 rotates the image data of the scan image by an amount of an angle of rotation of the mobile phone 10 from the normal position. In other words, in a case in which the mobile phone 10 has assumed the state of being rotated by 180 degrees from the normal position, the image data is rotated by 180 degrees. In a case in which the mobile phone 10 has not assumed a state of being rotated to left by 90 degrees from the normal position, the image data is rotated to left by 90 degrees. In a case in which the mobile phone 10 has assumed a state of being rotated to right by 90 degrees from the normal position, the image data is rotated to right by 90 degrees. In a state in which, the mobile phone 10 has assumed a state of normal position, the image data is rotated by zero degrees. In other words, the image data is not rotated.

Next, the process advances to step S234. At step S234, the CPU 12 stores the plurality of image data which has been subjected to rotation processing, in the image-file storage area 14a. Then the flow ends.

<Effect>

In the mobile phone 10 according to the second embodiment, when the user tilts the mobile phone 10 toward any one edge out of the four edges of the panel 22 on which the scan image is displayed, an edge portion of the scan image equivalent to that edge is set as the binding edge. In other words, when the user tilts the mobile phone 10 such that the plurality of documents bound are turned over, a direction in which the mobile phone 10 is tilted, or in other words, the tilting direction is set as the binding edge of the scan image. Accordingly, the user is capable of setting the binding edge of the scan image intuitively.

Moreover, the image data of the scan image is rotated by an amount equivalent to the angle of rotation of the mobile phone 10 from the normal position. Accordingly, in the MFP 50, even in a case in which the document has not been scanned in a state of being directed in an appropriate direction, it is possible to store the image data of the scan image in the image-file storage area 14a in a state of being directed in the appropriate direction. In other words, it is possible to store the image data of the scan image in the image-file storage area 14a in a state in which the image data of the scan image can be viewed straight.

### Modified Embodiments

In the second embodiment, the image data for setting the binding edge is data which has been received from the MFP 50 or the web server 82. However, it is possible to acquire the image data for setting the binding edge by various methods. For instance, it may be a method of acquiring image data from a non-volatile memory inserted into a memory slot which is not shown in the diagram.

Moreover, in the second embodiment, in order to perform the double-sided printing, the binding edge has been set. However, the binding edge may be set for providing a margin which becomes a binding margin, irrespective of the double-sided printing only. In other words, the binding edge may be set in order to set a position of a margin at the time of one-sided printing.

Moreover, in the first embodiment, the binding edge of the print image 100 has been set by the flic operation on the panel 22. However, the binding edge may be set by a touch operation on the panel 22. Concretely, four selection buttons corresponding to four edges which are included in the panel 22 may be displayed on the panel 22, and the binding edge may be set by touching one of the four selection buttons. Moreover, even without displaying the selection buttons, the binding edge may be set by touching a surrounding area of any one of the four edges which are included in the panel 22. Edges which are included in the panel 22 may be straight lines, and may be curved lines or wavy lines

In the second embodiment, setting of the binding edge has been carried out in a case in which the mobile phone 10, after being tilted in the first tilting direction, is returned to the original position, or in other words, is returned to the second tilting direction. However, it is possible to set the binding edge by various tilting methods. For instance, the mobile phone 10 may be rotated to complete one rotation in the first tilting direction, and the binding position may be set according the direction of rotation. Moreover, in a case in which the mobile phone 10 is tilted in a vertical direction, or in other words, is tilted in a direction of gravitational force, and the binding edge may be set according to the direction of gravitational force.

Moreover, in the second embodiment, the tilting sensor 30 has been provided to compute the posture and the tilting direction of the mobile phone 10. However, it is possible to compute the posture and the tilting direction of the mobile phone 10 by various sensors. For instance, it is possible to compute the posture and the tilting direction of the mobile phone 10 by the acceleration sensor 28.

It is possible to compute the posture of the mobile phone 10 by a processing based on the print application 32a or by a processing based on the scan application 32b. Concretely, in the processing based on the print application 32a or in the processing based on the scan application 32b for example, the CPU 12 acquires the tilting angle from a horizontal direction of the long edge of the mobile phone 10, by various sensors, and makes a judgment of whether or not the tilting angle acquired is not less than a predetermined angle A (for example 50 degrees). In a case in which the tilting angle acquired is not smaller than the predetermined angle A, the display mode according to the portrait mode may be selected, and in a case in which the tilting angle acquired is smaller than the predetermined angle A, the display mode according to the landscape mode may be selected. Moreover, for instance, the CPU 12 acquires the tilting angle from the horizontal direction of the long edge of the mobile phone 10 and the tilting angle from the horizontal direction of the short edge of the mobile phone 10 by various sensors, and makes a judgment of whether or not the tilting angle acquired is not less than a predetermined angle B (for example, 10 degrees). In a case in which the tilting angle of the long edge is not smaller than the predetermined angle B, the display mode according to the portrait mode may be selected, and in a case in which the tilting angle of the short edge is not smaller than the predetermined angle B, the display mode according to the landscape mode is may be selected. The posture of the mobile phone 10 may be computed by a processing based on an OS which stands for an operating system. In this case, in the processing based on the print application 32a or the processing based on the scan application 32b, the CPU 12 acquires information indicating the posture of the mobile phone 10 which has been computed by the processing based on the OS, by using the API. In a case in which, the information acquired indicates that the mobile phone 10 is in the landscape posture, the display mode according to the landscape mode may be selected, and in a case in which the information acquired indicates that the mobile phone 10 is in the portrait posture, the display mode according to the portrait mode may be selected.

As long as an apparatus in which an image based on image data is displayed, and in which it is possible to set a binding edge for the image displayed, is a portable apparatus, the apparatus is not restricted to the mobile phone 10. For instance, it may be a laptop computer or a tablet computer.

In the mobile phone 10 according to the first embodiment and the second embodiment, various processings are executed by the CPU 12 which executes based on the print application 32a or the scan application 32b. However, the present teaching is not restricted to the first embodiment and the second embodiment. The CPU 12 which executes according to the print application 32a or the scan application 32b, may give instructions for executing various processing, to the operating system 32d, other systems, and a hardware configuration.

Moreover, technology components which have been described in the present specification or diagrams are components which exert a technical usability individually or by various combinations, and are not restricted to combinations which are described in claims at the time of filing. Moreover, the technologies which have been exemplified in the present specification or diagrams are technologies which achieve a plurality of objects simultaneously, and not technologies having a technical usability by achieving one of the plurality of objects. Moreover, at step S106, the CPU 12 may recognize, as a lower edge, one edge which is positioned at a side closest to the button installed on the mobile phone 10; recognize, as a upper edge, one edge which is positioned at a side farthest from the button installed on the mobile phone 10; and recognize, as left and right edges, two edges which are intervened between the upper and lower edges. In this case, it can be considered that, at step S106, the CPU 12 absolutely identify each of the four edges (that is, the upper edge, the lower edge, the left edge and the right edge) included in the panel 22 based on a structure of the mobile phone 10.

The mobile phone 10 is an example of a portable terminal. The CPU 12 is an example of a computer. The panel 22 is an example of a display section, the button input section 20 and the tilting sensor 30, are examples of a sensor. The print application 32a and the scan application 32b are example of a computer program. The CPU 12 which executes steps S104 and S204 is an example of an image display mechanism. The CPU 12 which executes steps S108, S112, S116, S120, S208, S212, S216, and S220 is an example of binding edge setting mechanism. The CPU 12 which executes steps S124 and S228 is an example of an image-data processing mechanism.

Each computer program may be a computer program which includes one computer-program module or may be a computer program which includes a plurality of computer-program modules. Moreover, each example may be another arrangement which is replaceable, and is in a category of the present teaching. The computer may be a computer such as the CPU 12 which executes processing based on a computer program such as the print application 32a and the scan application 32b, or may be a computer which executes processing based on a computer program other than the computer programs in the abovementioned embodiments, such as the operating system and other applications, and the computer programs, or may be a hardware configuration such as the panel 22, which is operated according to instructions from the computer, or may be a configuration in which a computer and a hardware configuration are synchronized. As a matter of course, the computer may be a computer which executes processing upon synchronizing processing according to a plurality of computer programs, or may be a hardware configuration which is operated according to instructions from a computer which executes processing upon synchronizing processing according to a plurality of computer programs.

The abovementioned computer program can be provided as a recording medium such as a CDROM, a DVD, and a blue-ray disc. Alternatively, the abovementioned computer program can be provided as a recording medium such as a memory disc and a hard disc installed in the computer.

What is claimed is:

1. A non-transitory computer readable medium comprising a program recorded therein which is to be executed on a computer of a portable terminal including:
a display section including four edges; and
a sensor configured to output sensor data based on at least one of a sliding of an input medium being in a proximity to the display section, a sliding of the input medium contacting with the display section, and a posture of the portable terminal,
wherein the program causes the computer of the portable terminal to execute:
displaying an image based on image data on the display section;
setting a binding edge based on the sensor data output from the sensor, the binding edge being used at the time of printing the image displayed on the display section; and
processing the image data based on the set binding edge.

2. The computer readable medium according to claim 1, wherein under a condition that a plurality of images is displayed on a display screen of the display section, the binding edge is set, by the setting the binding edge, so that an edge of the display screen corresponding to edges of the plurality of images, each of which is located at a same side among the plurality of images, is set as the binding edge.

3. The computer program according to claim 1, wherein the sensor is configured to output the sensor data based on at least one of the sliding of the input medium being in a proximity to the display section and the sliding of the input medium contacting with the display section, and
the setting the binding edge includes obtaining a direction of sliding of the input medium based on the sensor data output from the sensor, and setting the binding edge based on the direction of the sliding of the input medium.

4. The computer readable medium according to claim 3, wherein the setting the binding edge further includes setting the binding edge such that, out of the four edges which are included in the display section, an edge which is positioned toward the direction of sliding of the input medium becomes a binding edge.

5. The computer readable medium according to claim 4, wherein under a condition that the image is displayed on the display section by the displaying the image, the setting the binding edge further includes:
setting an upper edge, of the image displayed on the display section, at a side of an upper edge of the display section, out of four edges included in the displayed image displayed on the display section, as a binding edge, under a condition that the sliding of the input medium is directed toward the upper edge of the display section;
setting a lower edge, of the image displayed on the display section, at a side of a lower edge of the display section, out of four edges included in the displayed image displayed on the display section, as a binding edge, under a condition that the sliding of the input medium is directed toward the lower edge of the display section;
setting a right edge, of the image displayed on the display section, at a side of a right edge of the display section, out of four edges included in the displayed image displayed on the display section, as a binding edge, under a condition that the sliding of the input medium is directed toward the right edge of the display section; and
setting a left edge, of the image displayed on the display section, at a side of a left edge of the display section, out of four edges included in the displayed image displayed on the display section, as a binding edge, under a condition that the sliding of the input medium is directed toward the left edge of the display section.

6. The computer readable medium according to claim 5, wherein the upper edge, the lower edge, the left edge and the right edge of the display section are relatively identified based on the posture of the portable terminal.

7. The computer readable medium according to claim 5, wherein the upper edge, the lower edge, the left edge and the right edge of the display section are absolutely identified based on a structure of the portable terminal.

8. The computer readable medium according to claim 4, wherein a plurality of images based on a plurality of pieces of image data is displayed on the display section by the displaying the image,
under a condition that the plurality of images are displayed on the display section by the displaying the image, the setting the binding edge further includes:
setting an upper edge, of the images displayed on the display section, at a side of an upper edge of the display section, out of four edges included in the each of the displayed images displayed on the display section, as a binding edge, under a condition that the sliding of the input medium is directed toward the upper edge of the display section;
setting a lower edge, of the images displayed on the display section, at a side of a lower edge of the display section, out of four edges included in the displayed images displayed on the display section, as a binding edge, under a condition that the sliding of the input medium is directed toward the lower edge of the display section;
setting a right edge, of the images displayed on the display section, at a side of a right edge of the display section, out of four edges included in the displayed images displayed on the display section, as a binding edge, under a condition that the sliding of the input medium is directed toward the right edge of the display section; and
setting a left edge, of the images displayed on the display section, at a side of a left edge of the display section, out of four edges included in the displayed images displayed on the display section, as a binding edge, under a condition that the sliding of the input medium is directed toward the left edge of the display section.

9. The computer readable medium according to claim 5, wherein the upper edge, the lower edge, the left edge and the right edge of the display section are relatively identified based on the posture of the portable terminal.

10. The computer readable medium according to claim 5, wherein the upper edge, the lower edge, the left edge and the right edge of the display section are absolutely identified based on a structure of the portable terminal.

11. The computer readable medium according to claim 4, wherein under a condition that the image is displayed on the display section by the displaying the image, the setting the binding edge further includes:
setting an upper edge of the image displayed on the display section as a binding edge, under a condition that the sliding of the input medium is directed toward an upper edge of the display section;
setting a lower edge of the image displayed on the display section as a binding edge, under a condition that the sliding of the input medium is directed toward a lower edge of the display section;
setting a right edge of the image displayed on the display section as a binding edge, under a condition that the sliding of the input medium is directed toward a right edge of the display section; and
setting a left edge of the image displayed on the display section as a binding edge, under a condition that the sliding of the input medium is directed toward a left edge of the display section.

12. The computer readable medium according to claim 1, wherein
the sensor is configured to output the sensor data based on the posture of the portable terminal, and
the setting the binding edge includes obtaining a direction of tilt resulted from a change in the posture of the portable terminal based on the sensor data output from the sensor, and setting the binding edge based on the direction of tilting of the portable terminal.

13. The computer readable medium according to claim 12, wherein under a condition that a direction directed from one surface of the portable terminal on a side at which the display section is provided, to a rear surface of the one surface of the portable terminal is defined as a first tilting direction, the setting the binding edge includes setting the binding edge such that, out of the four edges which are included in the display section, an edge which moves in the first tilting direction due to the tilting of the portable terminal becomes a binding edge.

14. The computer readable medium according to claim 12, wherein a plurality of images based on a plurality of pieces of image data is displayed on the display section by the displaying the image,
under a condition that the images are displayed on the display section by the displaying the image, the setting the binding edge further includes:
setting an upper edge, of the images displayed on the display section, at a side of an upper edge of the display section, out of four edges included in the displayed images displayed on the display section, as a binding edge, under a condition that the upper edge of the display section is tilted, relative to a lower edge of the display section, toward a first tilting direction directed from one surface of the portable terminal on a side at which the display section is provided, to a rear surface of the one surface of the portable terminal;
setting a lower edge, of the images displayed on the display section, at a side of the lower edge of the display section, out of four edges included in the displayed images displayed on the display section, as a binding edge, under a condition that the lower edge of the display section is tilted, relative to the upper edge of the display section, toward the first tilting direction;
setting a right edge, of the images displayed on the display section, at a side of a right edge of the display section, out of four edges included in the displayed images displayed on the display section, as a binding edge, under a condition that the right edge of the display section is tilted, relative to a left edge of the display section, toward the first tilting direction; and
setting a left edge, of the images displayed on the display section, at a side of the left edge of the display section, out of four edges included in the displayed images displayed on the display section, as a binding edge, under a condition that the left edge of the display section is tilted, relative to the right edge of the display section, toward the first tilting direction.

15. The computer readable medium according to claim 12, wherein under a condition that the image is displayed on the display section by the displaying the image, the setting the binding edge further includes:
setting an upper edge of the images displayed on the display section as a binding edge, under a condition that the upper edge of the display section is tilted, relative to a lower edge of the display section, toward a first tilting direction directed from one surface of the portable terminal on a side at which the display section is provided, to a rear surface of the one surface of the portable terminal;
setting a lower edge of the images displayed on the display section as a binding edge, under a condition that the lower edge of the display section is tilted, relative to the upper edge of the display section, toward the first tilting direction;
setting a right edge of the images displayed on the display section as a binding edge, under a condition that the right edge of the display section is tilted, relative to a left edge of the display section, toward the first tilting direction; and
setting a left edge of the images displayed on the display section as a binding edge, under a condition that the left edge of the display section is tilted, relative to the right edge of the display section, toward the first tilting direction.

16. The computer readable medium according to claim 1, wherein the displaying the image includes displaying a binding-edge image indicating the set binding edge and the image displayed on the display section by displaying the image, every time the binding edge is set by the setting the binding edge.

17. The computer readable medium according to claim 1, wherein the processing the image data includes generating printing data for printing an image of image data which is a base of the image displayed on the display section by the displaying the image, in accordance with the binding edge set by the setting the binding edge.

18. The computer readable medium according to claim 1, wherein the processing the image data includes generating printing data, to perform double-sided printing of an image of image data which is a base of the image displayed on the display section by the displaying the image, in accordance with the binding edge set by the setting the binding edge, the printing data including printing data for an image of a front page and printing data for an image of a rear page which is rotated with respect to the image of the front page.

19. A portable terminal comprising:
a display section including four edges;
a sensor configured to output sensor data based on at least one of a sliding of an input medium being in a proximity to the display section, a sliding of the input medium contacting with the display section, and a posture of the portable terminal; and
a control device configured to:
displaying an image based on image data, on the display section;
setting a binding edge at the time of printing the image displayed on the image section, based on the sensor data output from the sensor; and
processing of the image data based on the set binding edge.

20. A method of data processing for image data, comprising:
displaying an image based on image data, on a display section including four edges;
setting a binding edge at the time of printing of the image displayed on the display section, based on sensor data output by a sensor which is configured to output the sensor data based on at least one of a sliding of an input medium being in a proximity to the display section, a sliding of the input medium contacting with the display section, and a posture of a portable terminal, and
processing the image data based on the set binding edge.
